(19) United States
(12) Patent Application Publication
(10) Pub. No.: US 2012/0317040 A1
(43) Pub. Date: Dec. 13, 2012

(54) Patent Value Prediction

(75) Inventor: Monte J. Shaffer, Columbia Falls, MT (US)

(73) Assignee: Entrepreneurial Innovation, LLC., Tucson, AZ (US)

(21) Appl. No.: 13/479,136

(22) Filed: May 23, 2012

Related U.S. Application Data
(60) Provisional application No. 61/494,821, filed on Jun. 8, 2011.

(51) Int. Cl. G06Q 90/00

(52) U.S. Cl. 705/310

(57) ABSTRACT

Techniques for calculating patent value and predicting patent potential are described herein. These techniques may include calculating the value of a patent based on associations between a patent and other patents. The value of the patent may be calculated based on a citation in another patent to the patent, and a citation in the patent to a further patent. These techniques may also include predicting a potential value of a patent on the basis of a plurality of patent values and displaying this potential to a user.

### CROSS-REFERENCE TO RELATED APPLICATIONS

This application claims priority to U.S. Application No. 61/494,821, filed on Jun. 8, 2011, the entire contents of which are incorporated herein by reference.

### BACKGROUND

Patent holders and other organizations strive to estimate a patent's current and potential value. To calculate such value, these patent holders may make estimations based on subjective perceptions of the market, products, and technology. While this strategy may provide some indication of a patent's value, patent holders continually strive to enhance the accuracy of such estimations.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates an example architecture in which patent value calculation, prediction, and other claimed techniques may be implemented.

FIG. 2 illustrates an example patent network and associations among the patents within the network.

FIG. 3 illustrates a table corresponding to the associations of the patent network of FIG. 2.

FIG. 4 illustrates an example of a patent network having a super node.

FIG. 5 illustrates an example an algorithm in one aspect of the disclosure.

FIG. 6 illustrates an example matrix having weighted elements.

FIG. 7 illustrates an example augmented matrix having weighted elements.

FIG. 8 illustrates an example process for employing the techniques described herein.

FIG. 9 illustrates an example of a graph plotting a plurality of a patent's value over time.

FIG. 10 illustrates an example trajectory model of the graph shown in FIG. 9.

FIGS. 11a-d illustrate example graphs of patent's values over a period of time.

FIGS. 12a-d illustrate example trajectory models corresponding to the graphs shown in FIGS. 11a-d, respectively.

FIG. 13 illustrates, with an example data set, general trends regarding the size of the network formation at a specific marginal time.

FIGS. 14a-c illustrate example distributions for an example data set using a model specification.

FIGS. 15a-b illustrate example processes for employing the techniques described herein.

FIGS. 16a-c illustrate example distributions for an example data set.

### SUMMARY

This disclosure is related to, in part, calculating a value of a patent. For example, a value of a particular patent may be calculated by identifying a forward citation and a backward citation of the particular patent, weighting at least one of the forward and backward citations, and calculating the value of the particular patent based at least in part on the weighted citation. The forward citation may correspond to a citation in another patent to the particular patent, and the backward citation may correspond to a citation in the particular patent to a further patent.

This disclosure is also related to, in part, predicting a potential value of a patent. For example, a potential value of a patent may be predicted by calculating a plurality of patent values for a patent, and generating a predicted potential value of the patent based at least in part on the plurality of patent values. Each of the plurality of patent values may comprise the patent value of the patent at a respective point in time. Meanwhile, the predicted potential value of the patent may at least partly represent a future value of the patent.

### DETAILED DESCRIPTION

This disclosure is related to “Entrepreneurial Innovation: Patent Rank and Marketing Science,” Monte J. Shaffer, the entire contents of which are incorporated herein by reference.

This disclosure is directed to, in part, calculating the value of a patent based on associations between the patent and other patents. For example, the value of a particular patent may be calculated based on a citation in another patent to the particular patent (e.g., a forward citation), and a citation in the particular patent to a further patent (i.e., a backward citation). These citations may also be weighted to account for the values of the other patents.

For example, in a network of three or more patents, the value of a patent may be calculated based on the citations of the patents to each other and the corresponding values of all the patents in the network. In one instance, a first patent may include a citation from a second patent filed or granted subsequent to the first patent (e.g., a forward citation), and a citation to a third patent filed or granted prior to the filing or granting of the first patent (e.g., a backward citation). These forward and backward citations may be weighted based on the value of the patent from which the citation originates or terminates. In this instance, the value of the patent may be calculated based on the weighted citations to and from the first patent, rendering a value with respect to the other patents in the network (i.e., the second and third patents in the instant example).

In a further example, a value of a particular patent in a network at a particular time may be calculated by identifying each citation to or from the particular patent, weighting these citations in relationship to each patent and each citation in the network formed at the particular point in time, and calculating the value based on the weighted citations. A citation may comprise a forward citation or a backward citation. The forward citation may correspond to a subsequent citation of the particular patent as prior art in a future patent, and may indicate a greater value of the particular patent. A backward citation may correspond to a citation by the particular patent to prior art of a historic patent, and may indicate a lesser value of the particular patent. The weighting of each citation may be based on, or relative to, each patent and each citation in the network formed at the particular time.

This disclosure is also related to predicting a potential value of a patent on the basis of a plurality of patent values. The techniques described below may also display this potential value to a user, potentially as the predicted value changes or has changed over time. For example, a plurality of values for a patent may be calculated representing the values of a patent at different times. The plurality of patents values may be values up to a particular point in time. These values may then facilitate generation of prediction data indicating a predicted potential of the patent (e.g., an expected lifetime value of the patent, a value of the patent at a future time). This potential may be displayed to a user in a static or dynamic manner to indicate the potential of the patent.

The discussion first includes a section entitled “Overview,” which provides a general overview of techniques of this disclosure. Second, a section entitled “Illustrative Example: A Network Approach” is included, which describes an example network-based technique to calculate patent value. Third, a section entitled “Illustrative Example: Utilizing Calculated Patent Scores” is provided, which describes techniques for calculating and utilizing patent scores. Fourth, a section entitled “Illustrative Example: Predicting Patent Value” provides a description of techniques to assess patent innovation and predict patent value. Lastly, a section entitled “Illustrative Example: Assessing Patent Value at a Firm Level” describes an example for applying the techniques discussed herein to assess patent value for a firm (e.g., a particular company, group, or other entity).

This brief introduction, including section titles and corresponding summaries, is provided for the reader's convenience and is not intended to limit the scope of the claims, nor the proceeding sections. Furthermore, the techniques described in detail below may be implemented in a number of ways and in a number of contexts. One example implementation and context is provided with reference to the following figures, as described below in more detail. It is to be appreciated, however, that the following implementation and context is but one of many.

### Overview

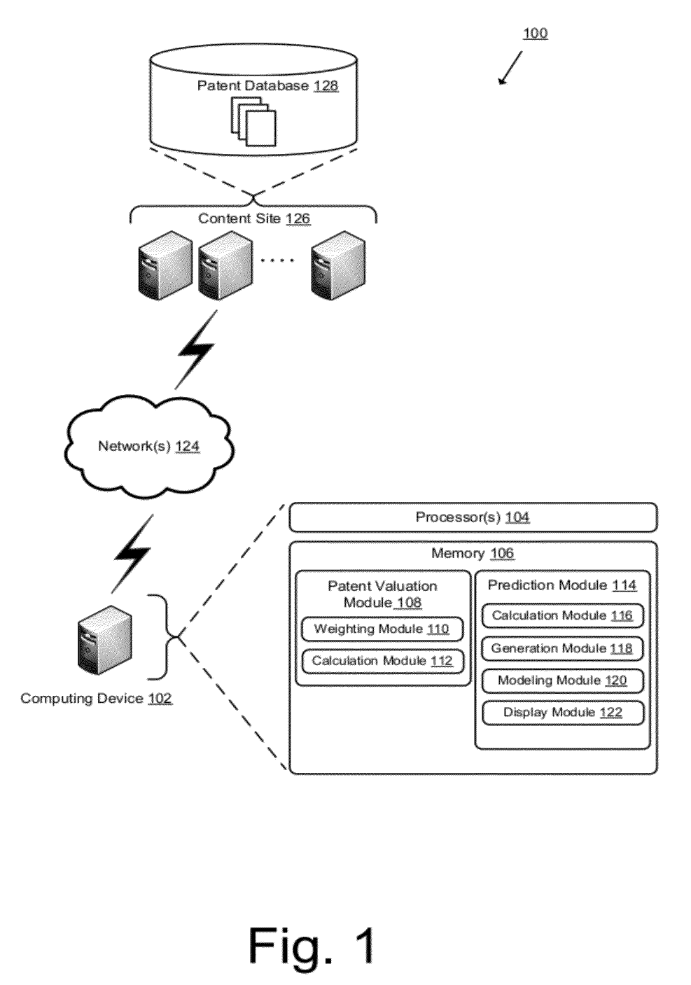

FIG. 1 illustrates an example architecture 100 in which patent value calculation, prediction, and other claimed techniques may be implemented. Here, the techniques are described in the context of a computing device 102 to access a content site 126 over a network(s) 124. For instance, computing device 102 may access content site 126 to retrieve patent data from a patent database 128 storing a plurality of patents in an electronic format. As is known, these patents comprise documents that represent and elucidate a set of exclusive rights granted by a state, such as a national government, to an inventor or an assignee for a limited period of time. These patents are available to the public in exchange for this limited exclusivity. While the techniques described herein are illustrated with reference to patents, it is to be appreciated that these techniques may similarly apply to patent applications (published or unpublished), academic papers, and/or any other types of documents that utilize forward and/or backward citations.

In architecture 100, computing device 102 may comprise any combination of hardware and/or software resources configured to process data. Computing device 102 may be implemented as any number of computing devices, including a server, a personal computer, a laptop computer, and a cell phone. Computing device 102 is equipped with one or more processors 104 and memory 106. Processor(s) 104 may be implemented as appropriate in hardware, software, firmware, or combinations thereof Software or firmware implementations of processor(s) 104 may include computer-executable instructions written in any suitable programming language to perform the various functions described herein.

Memory 106 may be configured to store applications and data. An application, such as a patent valuation module 108 or a prediction module 114, running on computing device 102 computes a patent value and potential. Patent valuation module 108 may include a weighting module 110 which weights a citation(s), and calculation module 112 which calculates a patent value based at least on the weighted citation(s). For example, weighting module 110 may apply a scaling factor to a citation based on a strength of an association between two patents. Thereafter, calculation module 112 may calculate a patent value based on the weighted citation(s).

Prediction module 114, meanwhile, may include a calculation module 116, a generation module 118, a modeling module 120, and a display module 122. In one aspect, these modules facilitate prediction of a potential of a patent (e.g., an expected lifetime value of the patent). For example, calculation module 112 may calculate a plurality of patent values for a patent utilizing the technique discussed above with respect to calculation module 112, or other techniques, such as the Trajtenberg method discussed below. Meanwhile, generation module 118 may generate prediction data based on the plurality of patent values. This prediction data may indicate a predicted potential of the patent. In addition, modeling module 120 may model a trajectory of the patent based on the prediction data, while display module 122 may display or generate data to display the modeled trajectory.

Although memory 106 is depicted in FIG. 1 as a single unit, memory 106 may include one or a combination of computer-readable storage media. Computer-readable storage media includes, but is not limited to, volatile and non-volatile, removable and non-removable media implemented in any method or technology for storage of information, such as computer-readable instructions, data structures, program modules or other data. Additional types of computer storage media that may be present include, but are not limited to, PRAM, SRAM, DRAM, other types of RAM, ROM, electrically erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other medium which can be used to store the desired information and which can be accessed by a computing device.

Computing device 102 may also include communications connection(s) that allow computing device 102 to communicate with a stored database, another computing device or server, user terminals, and/or other devices on a network. Computing device 102 may also include input device(s) such as a keyboard, mouse, pen, voice input device, touch input device, etc., and output device(s), such as a display, speakers, printer, etc.

In the example of FIG. 1, computing device 102 accesses content site 126 via network 124. Network 124 may include any one or combination of multiple different types of networks, such as wireless networks, local area networks, and the Internet. Content site 126, meanwhile, may be hosted on one or more servers having processing and storage capabilities. In one implementation, content site 126 is implemented as a plurality of servers storing patent data in electronic format. For example, content site 126 may be the U.S. Patent and Trademark Office which provides access to patents in electronic format. However, other sites which store and provide access to patents or other documents are within the scope of this disclosure.

Here, content site 126 includes a patent database 128 storing patent data. The patent data may include any data relating to patents, such as patent numbers, filing dates, citations within the patents, assignee information, etc. Content site 126 may be configured to provide such patent data upon request from a computing device, such as computing device 102, or may be configured to automatically provide such data at regular intervals.

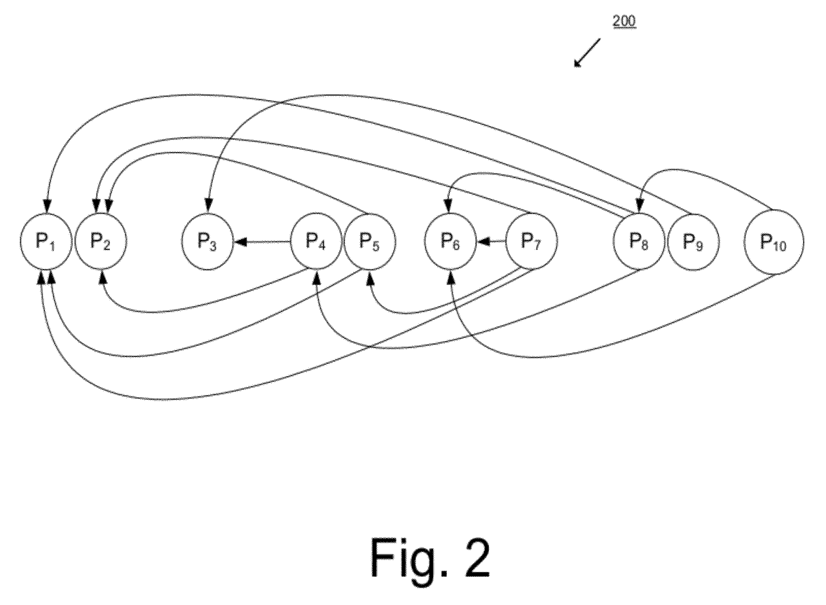

FIG. 2 illustrates an example patent network 200 and associations among the patents within network 200. Here, network 200 includes ten patents (i.e., nodes P₁-P₁₀) arranged in chronological order (e.g., P₁ was filed or granted before P₂, and so forth), and fourteen associations or links. Each node represents a patent and each arrow represents a citation in one patent to another patent. In this example, FIG. 2 may be referred to as a directed graph.

For example, a citation within P₅ to P₁ is represented as an arrow pointing from P₅ to P₁, and is defined herein as a backward citation for P₅. Meanwhile, a citation from another patent to P₅ is represented as an arrow pointing to P₅, and is defined herein as a forward citation for P₅. As illustrated, P₅ has a forward citation to P₇, as illustrated by the arrow pointing from P₇ to P₅. The arrow pointing from P₇ to P₅ also represents a backward citation for P₇. In this manner, a forward citation for one patent may represent a backward citation for another patent.

In one implementation, the patent data (e.g., filing dates, citation information, etc.) defining the associations of the patents in the network is obtained from a patent database. For instance, the patent data may be retrieved from a patent database 128 of content site 126. Alternatively, the patent data may be previously stored within a device implementing techniques described herein or provided to the device through a computer readable medium.

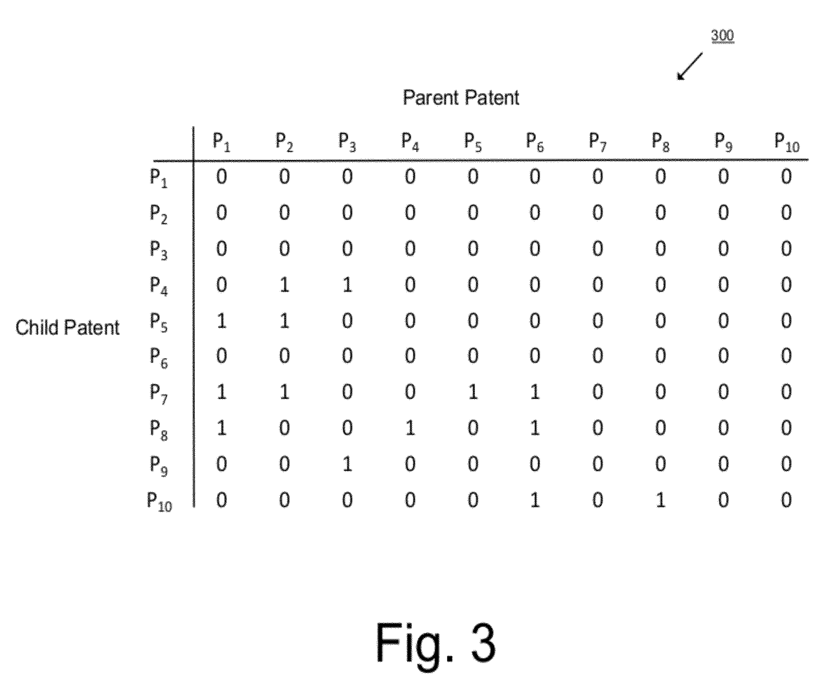

FIG. 3 illustrates a table 300 corresponding to the associations of patent network 200. The rows and columns of table 300 represent patents from the example shown in FIG. 2, and the elements in table 300 represent the associations between the patents. For example, the “1” illustrated at column P₁, row P₅, represents a citation in P₅ to P₁, and the “1” illustrated at column P₂, row P₅, represents a citation in P₅ to P₂. Although represented as binary values (i.e., “1”s and “0”s) in FIG. 3, these elements may also be weighted to represent non-binary values (e.g., a fraction, decimal, etc.), as described in detail below.

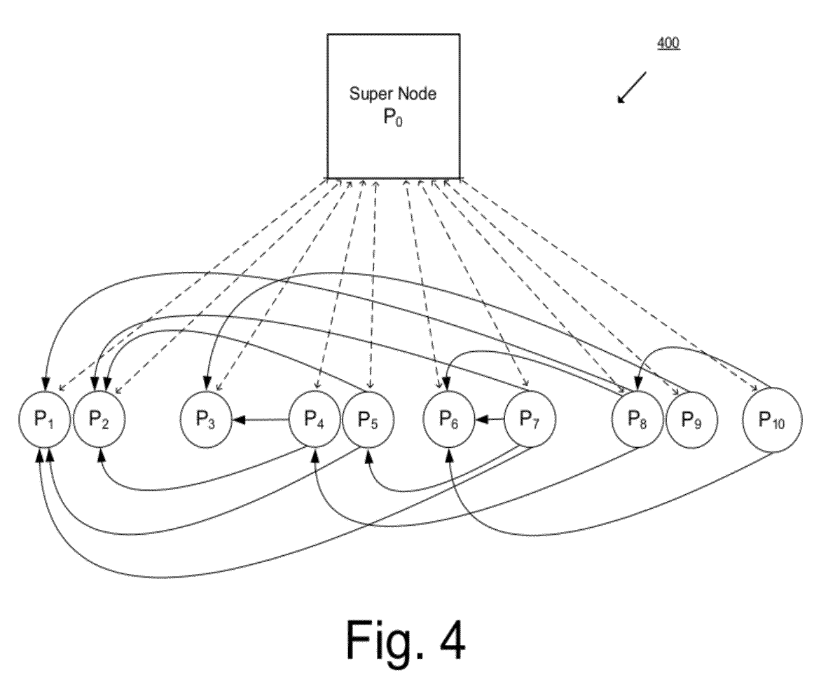

FIG. 4 illustrates an example of a patent network 400 having a super node. Patent network 400 is similar to patent network 200 with the addition of a super node (P₀).

Each arrow represents an association between the super node and a corresponding patent within network 400. Further, each arrow is bi-directional, representing an association from a patent to the super node and an association from the super node to the patent. For example, the arrow between P₁ and the super node represents an association from P₁ to the super node and an association from the super node to P₁. As in further detail hereafter, the addition of the super node helps facilitate computation of a value of a patent within the network. In one instance, the super node may be represented as the U.S. Patent and Trademark Office in the regulation of patent prosecution and determination of citations, which may facilitate formation of a patent network.

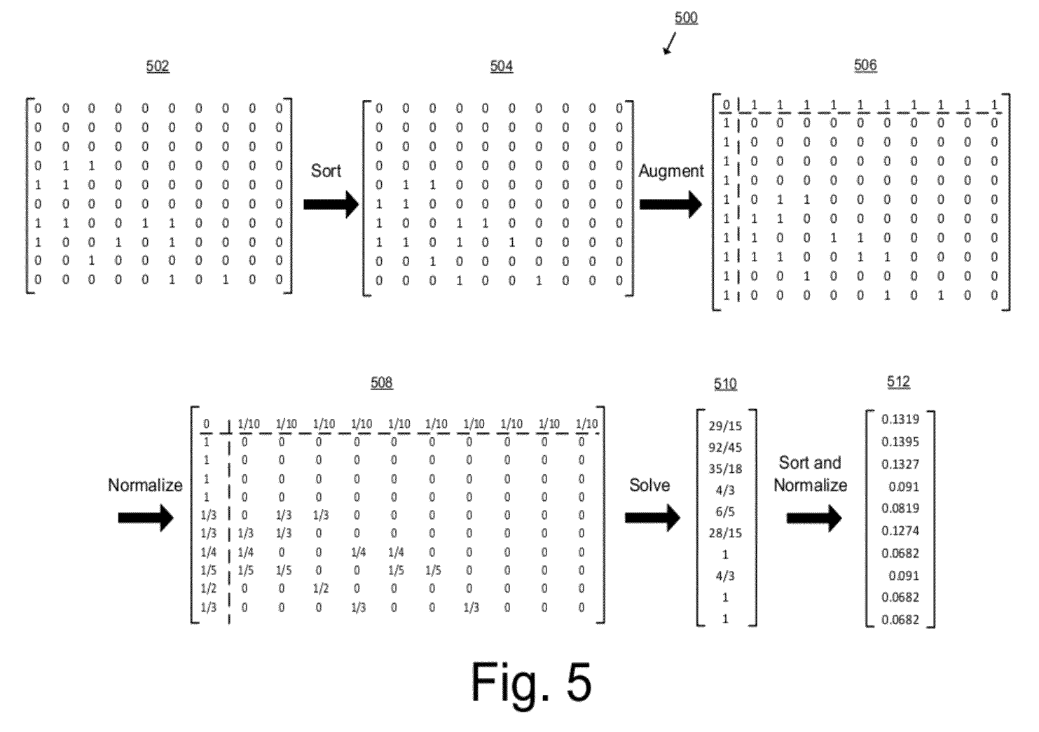

FIG. 5 illustrates an algorithm 500 utilized in one aspect of this disclosure. Algorithm 500 facilitates the computation of a value of a patent within a network, for example the value of a patent with network 200 or 400. The algorithm begins by forming a matrix 502. Here, matrix 502 represents the associations of the patents in patent network 200, which may comprise each patent granted within a particular country or countries, a subset of patents granted within one or more countries, or the like. For instance, the patent network 200 may comprise each patent granted by the United States Patent and Trademark Office (USPTO) over a specified timeframe.

Within matrix 502, each element represents a citation from one patent to another patent in the network. Here, each element in matrix 502 is represented as a binary value indicating that an association (i.e., a citation) does or does not exist. In matrix 502, a “1” indicates that an association exists and a “0” indicates that an association does not exist. Alternatively, as discussed in detail later, each element could be represented as a weighted element indicating a presence and/or strength of the association.

After matrix 502 is formed, matrix 502 is sorted (e.g., partitioned and/or reorganized) based on a classification of each patent (e.g., an ordering schema). In one implementation, the patents are classified based on the types of citations. For example, the patents may be classified into one of three categories, such as patents having forward citations but no backward citations (i.e., a “dangling patent”), patents having both forward and backward citations (i.e., a “core patent”), and patents having no forward citations (i.e., a “dud patent”). Here, the elements within matrix 502 are, sorted based on the classification of the patents. The sorting can also include ordering the elements by time.

Sorted matrix 504 is then augmented by adding a row and column to matrix 504, consequently, forming matrix 506. This step represents the addition of a super node, such as the super node shown in FIG. 4, to indicate a link to and from the super node. The addition of this row and column ensures that no row in the matrix will be all zeros, thus avoiding the scenario where the matrix is unsolvable. Next, matrix 506 is row-normalized to form matrix 508. This normalization may include calculating a sum for each row and dividing each element in the row by the corresponding sum for that row.

Row-normalized matrix 508 is then solved to identify a value of a patent (or a “patent score”). Matrix 508 can be solved by a power method or an efficient linear-algebra method. Thereafter, solved matrix 510 is sorted and normalized to output matrix 512. By solving this linear system a patent value can be calculated for one or all of the patents represented within matrix 502. In aspects of this disclosure, the patent values are calculated at a specified time (e.g., daily, weekly, monthly, annually, or the like), and the values are stored to monitor the patent's value over time.

After the value of the patent has been calculated, the value may be used for an array of purposes. For instance, the value may be used to estimate the current social value of the patent within a particular patent network or market, used to calculate the overall value of an organization or other entity, or used to determine a market value for which the patent can be sold.

In one example, a value of a patent may be used to estimate social value of a patent innovation (SV), firm value of the patent innovation (FV), or intellectual property value of the patent innovation (IPV). Social value may suggest society benefits, regardless of a firm's ability to extract profits. Meanwhile, firm value may suggest that the firm has other resources to leverage to create synergies. Further, intellectual property value may indicate a standalone value of the patent if traded.

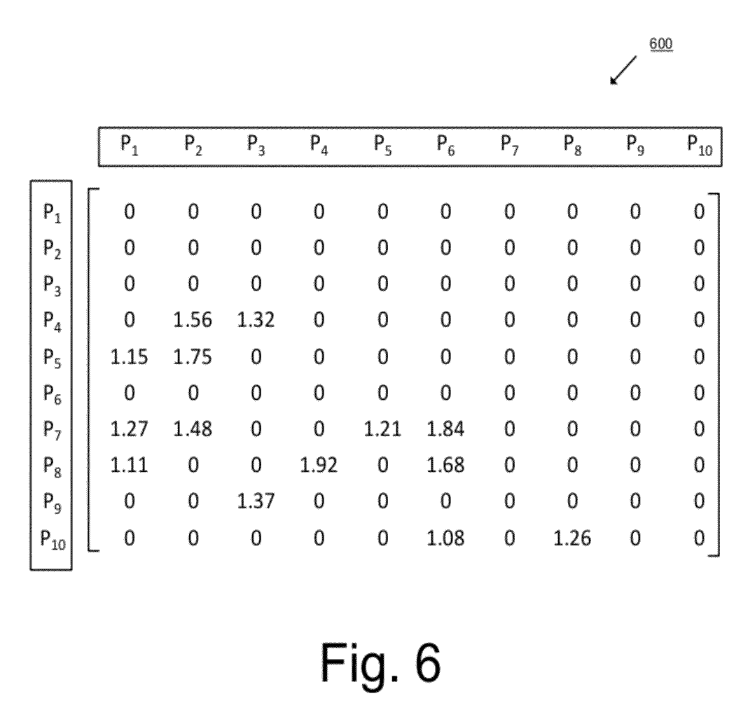

FIG. 6 illustrates an example matrix 600 having weighted elements, with this matrix being used in the process shown in FIG. 5 for the purpose of calculating a value of one or more patents within a patent network. Here, the weighted elements represent the strength of the citation. That is, the each of the weighted elements represents the strength of a citation between two particular patents. In one example, the weighted elements are constrained to positive values (e.g., greater than or equal to zero). The strength of the citation can be based on the value of the patent to which the citation corresponds, a measure of the similarity between the patents forming the association, and/or other factors. Matrix 600 illustrates, for instance, that the citation between P₁ and P₈ has a relatively low value of 1.11, as compared with the strength of the citation between P₂ and P₅ (1.75). By weighting citations between patents differently, matrix 600 results in a more accurate representation of a patent's value. Stated otherwise, because a first patent may cite more valuable patents as compared to a second patent, the first patent may be stronger and/or more valuable in society or in the market as compared to the second patent. Matrix 600 takes this extrinsic difference or endogenous consideration in account when calculating patent values within the network.

In one instance, the different weights within matrix 600 may be based on a similarity between two patents that are associated with a particular citation in matrix 600. In these instances, the measure of similarity may include similarity among a technology classification, a field of search, international classification, or other classification. Here, the weighted element of “1.15” between P₁ and P₅, indicates that the strength of the citation from P₅ to P₁ is less than the strength of the citation from P₅ to P₂, “1.75.” In one example, algorithm 500 processes this weighted matrix 600. In other words, matrix 600 would be substituted for matrix 502 shown in FIG. 5. Although the above discussion relates to a process of weighting each element within a matrix, this weighting process may equally be applied to one or less than all of the elements within a matrix.

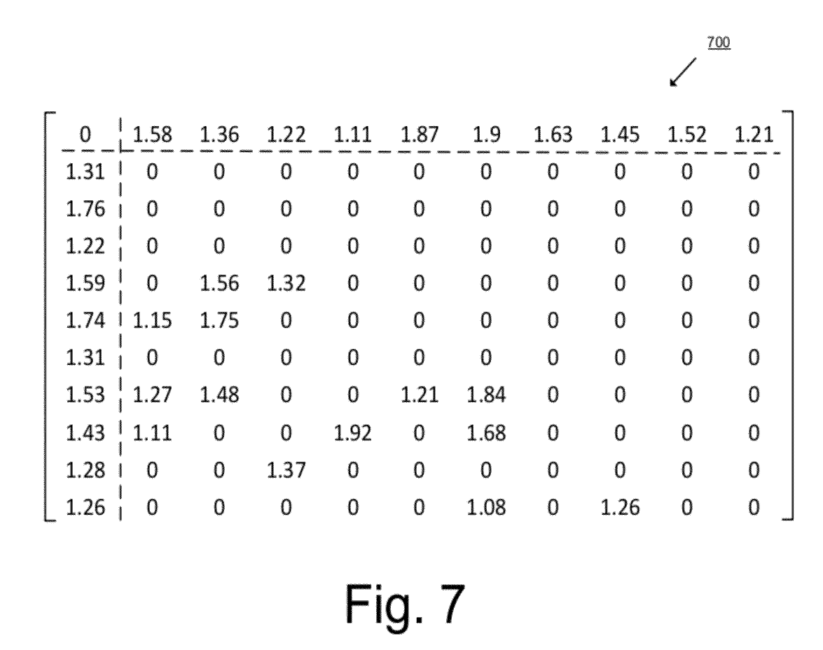

FIG. 7 illustrates an example augmented matrix 700 having weighted elements. Here, matrix 700 has been augmented by adding a row and a column including weighted elements. In this example, the weighted elements in the augmented row and column represent the strength of the association between the super node and corresponding patent. In one implementation, the U.S. Patent and Trademark Office represents the super node and the elements in the augmented row and column are weighted based on the association of the patent with the Patent Office. For example, the weighted value may be based on the time it took the patent to grant, industry controls, years remaining in the patent term, payment of renewal fees, a patent's litigation value, and/or other factors involving the association between the patent and the Patent Office. Of course, in some instances, the augmented matrix may weight each of the added elements the same (e.g., with a “1” or another number), as discussed above with reference to FIG. 5.

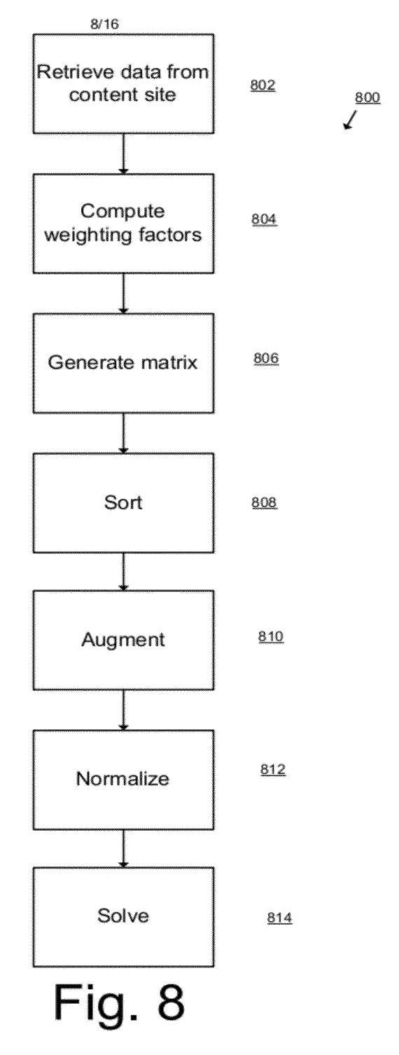

FIG. 8 illustrates an example process 800 for employing the techniques described above. The process 800 (as well as each process described herein) is illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

Process 800 includes an operation 802 for retrieving patent data from a content site, such as content site 126. In one example, content site 126 is the U.S. Patent and Trademark Office and the retrieving process includes retrieving patent data of all or a subset of patents stored at the Patent Office. The retrieval process may be performed at predetermined intervals or performed based on a user request, such as a request from computing device 102. The content site may provide patent data through a network, such as network(s) 124. As discussed above, this patent data may include any data associated with a patent. In one example, the patent data includes filing dates, citation information, assignee information, patent term dates, prosecution history information, maintenance information, fee data, technology classifications, etc. This data may be used in forming a matrix to calculate the value of a patent. For instance, the citation information may be used to determine associations among patents of a network. Meanwhile, other obtained information, such as a technology classification, can be used in weighting elements within the matrix.

Process 800 also includes an operation 804 for computing weighting factors. For example, operation 804 may include defining the weighting factors as binary values of “0”s and “1.” In this example, a matrix would thereafter be formed with elements represented as binary values. Alternatively, operation 804 may include computing a non-binary weighting factor which would be applied to elements of a matrix.

Process 800 also includes an operation 806 for generating a matrix (e.g., a directed graph in matrix form) based on the citation information retrieved in process 802 and/or weighting factors computed in operation 804. Further, process 800 includes an operation 808 for sorting the matrix. Operation 808 may include reorganizing elements within the matrix based on a classification of each patent. Further, process 800 includes an operation 810 for augmenting the matrix, which may comprise adding a row and a column to the matrix. Here, process 800 also includes an operation 812 for normalizing the matrix by summing values within a row and dividing the row by the summed value, and an operation 814 to solve the matrix. Operation 814 may include solving the matrix utilizing a power method or linear algebra method. In addition, operations 804-814 may include any of the techniques discussed above in reference to FIGS. 5-7.

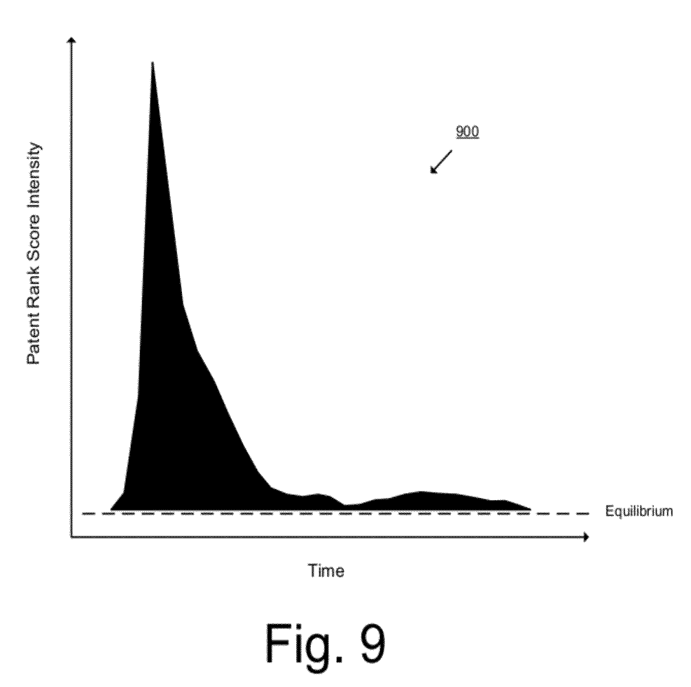

FIG. 9 illustrates an example of a graph 900 plotting a plurality of patent values (i.e., patent scores). In this example, the y-axis represents the intensity of the patent value (e.g., the intensity of a patent's value or patent score), and the x-axis represents time. A dotted line is illustrated, representing an equilibrium line of the patent values. In one instance, the equilibrium line indicates a reference for innovation within the market. In other words, a patent having a patent value greater than the equilibrium line indicates the patent as a radical innovation above a state of equilibrium within the market. Alternatively, or in addition, the equilibrium line may be defined by a minimum value emetically defined to be one based on a vector normalization in a solution, such as a solution from operation 814.

Here, FIG. 9 illustrates one example of a Schumpeterian shock (e.g., a disruption from market equilibrium that can be observed and measured). This shock may include definable characteristics, such as intensity, duration, and overall volume. Intensity indicates the maximum value or score a patent may receive over time, duration indicates the length of time the patent has a value or score greater than the equilibrium (e.g., a score of “1”), and volume indicates the total impact to the patent innovation (e.g., the shaded region). In one example, calculated scores may be utilized to identify a Schumpeterian shock, as described in further detail below.

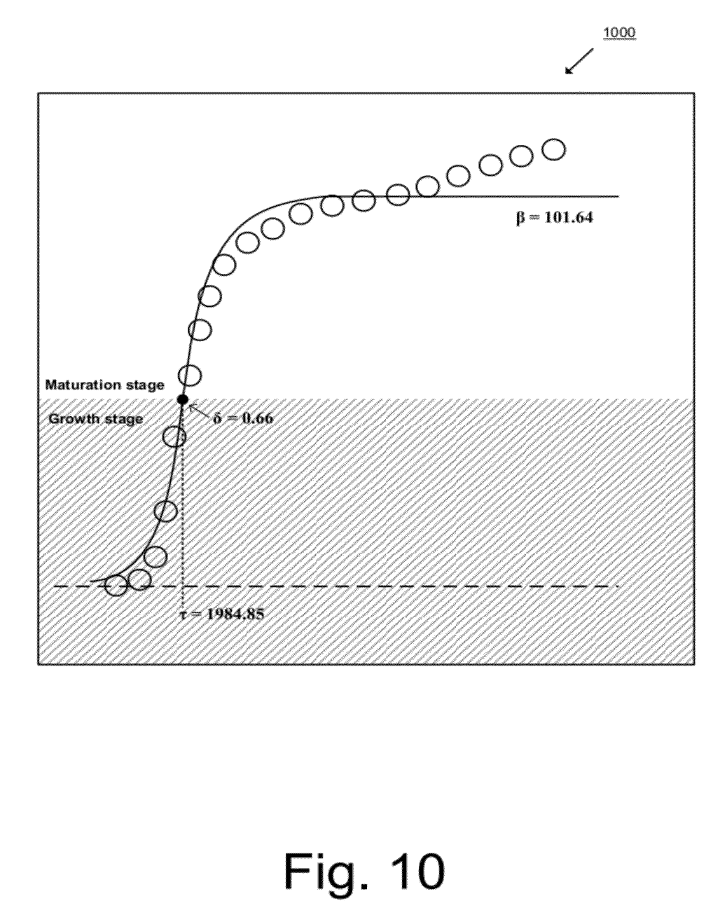

FIG. 10 illustrates an example trajectory model 1000 of the graph 900 shown in FIG. 9. Here, the trajectory of the shock illustrated in FIG. 9 is modeled using an S-curve. The y-axis represents growth and the x-axis represents time. Meanwhile, each dot (i.e., circle) illustrated in FIG. 10 represents a computed shaded region from the shock illustrated in FIG. 9. In aspects of this disclosure, this trajectory is utilized to model or estimate the potential of a patent (e.g., a total expected lifetime value of a patent). The trajectory model may include three parameters, a time of maximum growth τ (velocity), a maximum growth rate δ (growth), and a ceiling value β (volume) representing an expected total volume. In one implementation, a trajectory is modeled after a predetermined number of patent scores have been accumulated. For instance, a patent's value may be calculated at a number, N, different times (e.g., over the course of months, years, etc.), and the value may be predicted based on these N different values.

For purposes of predicting a value of patent at a particular point in time, the patent's value may be calculated using the weighted forward and backward citations, as described above. In other instances, meanwhile, the patent's value may be calculated using other techniques. For instance, the algorithm described above with reference to FIG. 5 may be used, with the initial matrix 502 including un-weighted citations. In a further instance, the patent's value may be calculated using techniques established by Manuel Trajtenberg, which calculate a patent's value based on un-weighted forward citations only.

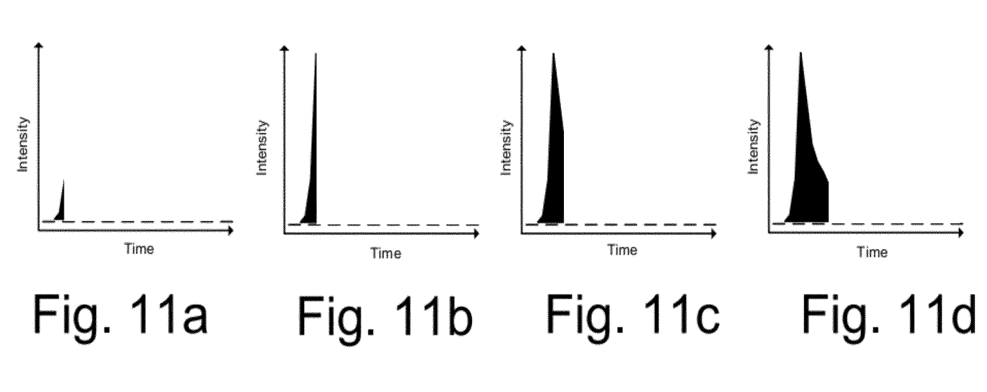

FIGS. 11a-d illustrate example graphs of patent scores, similar to the graph of FIG. 9, plotted over time. These graphs illustrate how the patent scores update over time. For example, FIG. 11a illustrates a graph of patent scores up to a time t₁ and FIG. 11b illustrates a graph of patent scores up to a time t₂. Similarly, FIGS. 11c and 11d illustrate graphs of patent scores up to times t₃ and t₄, respectively. In one instance, the graphs of FIGS. 11a-d may be utilized to monitor patent scores of a patent and predict a total cumulative value of the patent. The total cumulative value may correspond to a volume or area under a curve defined by the patent scores, such as one of the curves illustrated in FIGS. 11a-d.

In one example, FIGS. 11a-d are displayed to a user as an animation. Here, a computing device executes processing to display such graphs in a user interface. Meanwhile, a displayed animation would illustrate the change in patent value intensity over a period of time. Such animation may include displaying FIGS. 11a-d in order with other graphs displayed between to illustrate a continuous movement. As such, more of the intensity shock (e.g., the shaded region) would appear as the animation progresses in time.

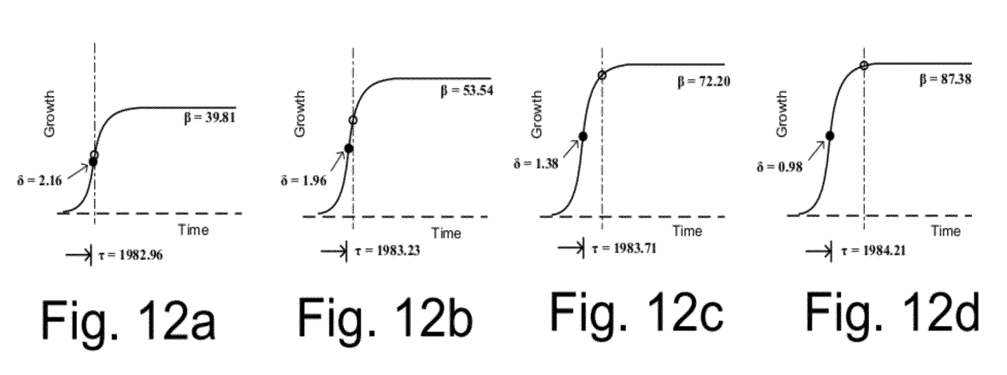

FIGS. 12a-d illustrate example trajectory models corresponding to the graphs shown in FIGS. 11a-d, respectively. These figures illustrate the change in growth of a patent over a period of time. Here, the y-axis represents growth and the x-axis represents time. As similarly discussed above for FIG. 10, three parameters are used to model a trajectory, δ, β, and τ.

In one example, these three parameters facilitate prediction of a patent's potential value. For example, a patent having a high expected value β may indicate a patent with a high expected lifetime value. Furthermore, a faster growth rate may indicate more potential for overall value of the patent.

Although the techniques discussed above in reference to FIGS. 9-12, were discussed in the context of patent scores, these techniques may be equally applied to patent values calculated through other methods. For example, patent values calculated based on only forward citations may be utilized in modeling a trajectory and/or predicting patent value.

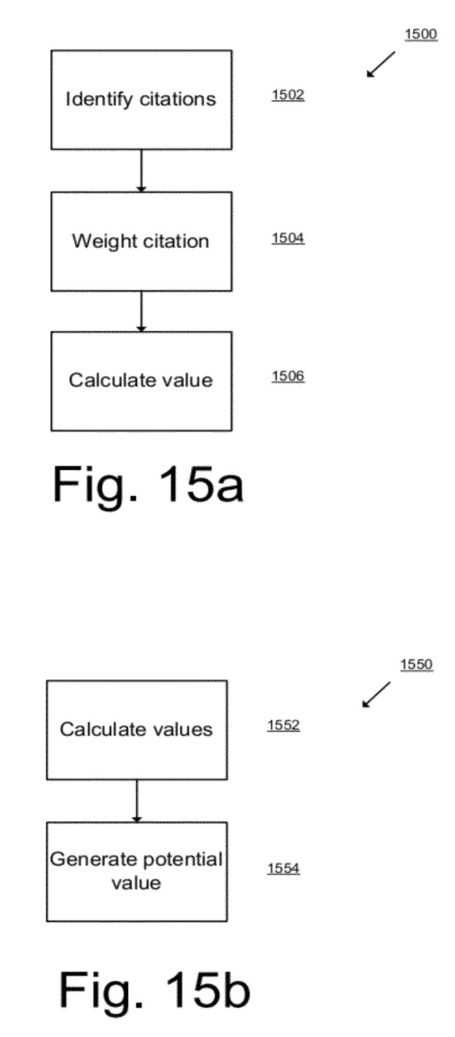

FIGS. 15a-b illustrate example processes for employing the techniques described above and below. In particular, FIG. 15a illustrates an example process 1500 for calculating a patent value. Process 1500 includes an operation 1502 for identifying citations of a patent, such as forward and backward citations of the patent. Operation 1502 may also include identifying each citation within a network. Process 1500 also includes an operation 1504 for weighting at least one of the citations of the patent, and an operation 1506 for calculating a value of the patent based at least in part on the weighted citation. Operation 1504 may also include weighting each citation endogenously (e.g., simultaneously considering each citation in a formed network). Meanwhile, operation 1506 may also include calculating each patent's value in a network.

FIG. 15b illustrates an example process 1550 for predicting a potential value of a patent. Process 1550 includes an operation 1552 for calculating a plurality of patent values for a patent, and an operation 1554 for generating a predicted potential value of the patent based at least in part on the plurality of patent values. Operation 1552 may also include recalculating a plurality of patent values at different points in time (e.g., a network updates). Meanwhile, operation 1554 may also include generating potential value of a patent from a trend of calculated values for a single patent.

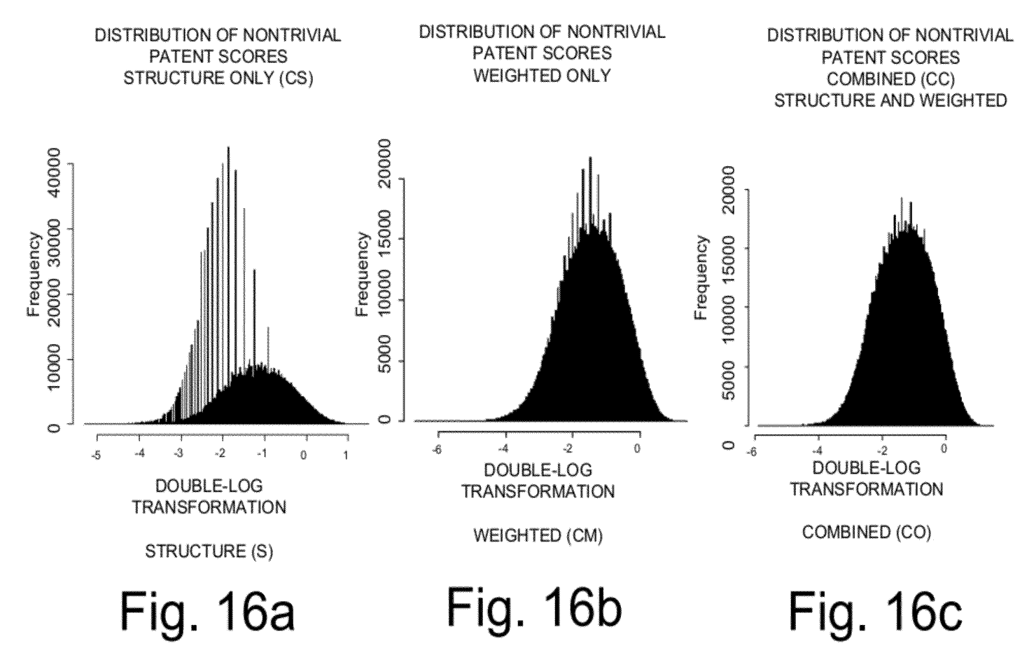

FIGS. 16a-c illustrate example distributions for an example data set. For example, FIG. 16a illustrate an example distribution of nontrivial patent scores with a structure model, FIG. 16b illustrates an example distribution of patent scores with a weighted model, and FIG. 16c illustrates an example distribution of patent scores with a combined model.

### ILLUSTRATIVE EXAMPLE

### A Network Approach

The following section describes techniques directed to calculating patent scores utilizing a network approach. In one example, a value of a patent is calculated utilizing the mathematics of eigenvector centrality.

Some studies in marketing science utilize patents to examine different aspects of innovation: to understand knowledge flow within and across firms, to describe how knowledge flow influences the success of innovation, and to identify antecedents and outcomes of radical and incremental product innovation. This research requires a metric to valuate patents. However, current systems of patent valuation are inadequate to meet this demand.

For example, simply counting the number of patents a firm possesses is insufficient, as each patent may have a different value and not all patents are created equal. In addition, it has been proposed to valuate an individual patent by counting subsequent patents that are legally-bound to cite the patent as prior art. These subsequent citations can be defined as forward citations. In many instances, these forward-citation counts represent, among patents, an inherent diffusion and adoption of the originating patent innovation, they represent an output measure of the innovative process. However, simply counting the number of forward citations a patent possesses may be insufficient in some circumstances, as each citation may have a different value and not all forward citations are created equal. Similarly, not all backward citations are created equal.

Therefore, aspects of this disclosure relate to a comprehensive, graph-based patent network using forward and backward citations. In this aspect, the value of each patent in the network is assessed by considering each patent-citation pair utilizing the mathematics of eigenvector-centrality, a procedure that is endogenous, simultaneous, comprehensive, and universal. This technique considers each patent-citation association and accounts for the importance of each association relative to the entire network. The resulting scores are referred to as patent values or scores.

Thus, aspects of this disclosure are directed to computing devices implementing refined logic to valuate patents, a comprehensive patent dataset to implement the logic, an intuitive, and network methodology to execute the logic. In general, the methods and systems provided herein provide an improved valuation-metric for patent innovations.

In aspects of this disclosure, the techniques described herein provide an advantage that patent holders and other organizations may valuate a patent based on objective measures. In one example, the valuation techniques include calculating a patent value based on citation information associated with the patent. Here, the citation information may provide objective information about the patent, and may be used to calculate a value of the patent.

As discussed hereafter, aspects of this disclosure relate to evaluating a patent's value based on forward and backward citations. For example, a patent X may be appraised at any point in time based on both its backward and forward citations. Backward citations may represent a borrowing of radicalness to X, and forward citations may represent a lending of radicalness from X. By considering both backward and forward citations simultaneously and endogenously, any patent X can be assessed based on its entire genealogy—its upstream antecedents and its downstream descendants at a particular moment in time. Consequently, this provides an advantage that an accurate patent value may be calculated, even when additional patents join the network.

Many aspects of this disclosure relate to network theory. Network theory is a type of graph theory that maps a network structure based on a defined association (link) between objects (node). Aspects of this disclosure define the patents as the objects, and define the forward and backward citations as the associations. A patent network can then be described as a directed graph, that is, the direction of the association defines whether the citation is a forward or backward citation. The resulting directed patent graph identifies the genealogy of each patent innovation.

In one example, FIG. 2 illustrates a network of ten patents having fourteen associations (links). FIG. 2 illustrates both the temporal constraints and citation associations of ten patents (P₁-P₁₀). In this example, the U.S. Patent and Trademark Office assigns an incremental number to each patent once it is granted, so patent P₁ is older than (or the same age as) patent P₂.

Here, forward citations for any patent X represent inbound links, and backward citations represent outbound links. In FIG. 2, patents P₁, P₂, and P₆ each have three forward citations, providing some support for innovation radicalness, and patent P₇ has four backward citations, suggesting innovation incrementalness. The table shown in FIG. 3 summarizes this patent graph. The rows and columns of the table represent the nodes (patents) of the graph, and the elements within the table indicate associations between the patents. Since this table consists of 100 elements (10×10), yet non-zero values are found in only fourteen cells, the table is defined as a sparse table.

In this example patent P₅ is defined as a core patent, as it has both forward and backward citations (P₄ and P₈ are also of this type), patent P₆ is defined as a dangling node, as it has forward citations, yet no backward citations (P₁, P₂, and P₃ are also of this type), and patent P₇ is defined as a dud patent, as it has no forward citations (P₉ and P₁₀ are also of this type).

Any elemental cell (r, c) in this table is a binary response that defines the link from the patent in the row (r) to the patent in the column (c). For example, (P₅, P₁) equals “1” as it represents a link from P₅→P₁. This defines a directional association, the reverse direction, (P₁, P₅) equals “0” because the association P₁→P₅ is not possible due to the temporal assignment of patents in chronological order (i.e., P₅ was filed or granted after P₁). Therefore, the rows represent backward citations and the columns represent forward citations. For example, row P₅ identifies two backward citations P₁ and P₂, and column P₅ identifies one forward citation P₇. Since, by definition, a node does not cite itself, cell (P₅, P₅) is equal to zero.

In Equation (2.1) shown below, a matrix M is derived from the directed associations of the network shown in FIG. 3:

$$M = [ \begin{matrix}0 & 0 & 0 & 0 & 0 & 0 & 0 & 0 & 0 & 0 \\ 0 & 0 & 0 & 0 & 0 & 0 & 0 & 0 & 0 & 0 \\ 0 & 0 & 0 & 0 & 0 & 0 & 0 & 0 & 0 & 0 \\ 0 & 1 & 1 & 0 & 0 & 0 & 0 & 0 & 0 & 0 \\ 1 & 1 & 0 & 0 & 0 & 0 & 0 & 0 & 0 & 0 \\ 0 & 0 & 0 & 0 & 0 & 0 & 0 & 0 & 0 & 0 \\ 1 & 1 & 0 & 0 & 1 & 1 & 0 & 0 & 0 & 0 \\ 1 & 0 & 0 & 1 & 0 & 1 & 0 & 0 & 0 & 0 \\ 0 & 0 & 1 & 0 & 0 & 0 & 0 & 0 & 0 & 0 \\ 0 & 0 & 0 & 0 & 0 & 1 & 0 & 1 & 0 & 0\end{matrix} ] . \qquad ( 2.1 )$$

Within network analysis there are several centrality measures. In one aspect of this disclosure, eigenvector centrality is utilized as it considers each association in the network simultaneously. Generally, this approach considers information about both forward and backward citations simultaneously and endogenously. This provides the advantage that bias is removed from considering forward or backward citations individually.

Considering the two-dimensional form from Equation (2.1), in the preferred aspect of this disclosure, the importance of a patent may not only be measured by the number of forward and backward citations it has, but also by the relative importance of these citations, as measured by their respective forward and backward citations, and in turn, these forward and backward citations are measured by their respective forward and backward citations. This endogenous and recursive consideration is mathematically defined as a Markov process and can be computed using eigenvector centrality.

In order to compute the eigenvector centrality of a network, certain mathematical properties must exist. A fundamental theorem in linear algebra (the Perron-Frobenius Theorem) states that if a matrix is irreducible and non-negative, a unique eigenvector for the matrix can be identified. This means that a network structure of size n×n (from Equation (3.2) or the table shown in FIG. 3) can be collapsed into a vector of n unique scores (the eigenvalues). Essentially, this theorem allows for the computation of a patent score for each patent in the network and assures a converged, unique solution.

To be able to apply the Perron-Frobenius Theorem, it is worth noting that, by construction, matrix M is non-negative, that is, every element (mᵢⱼ) in the matrix is greater than or equal to zero. Utilizing principles of linear algebra, the matrix M needs to be transformed into irreducible matrix P. In the preferred aspect of this disclosure, once matrix P is appropriately specified, the computation of the eigenvector π will define the patent scores:

π=P^{T}π where P=diag(d)⁻¹M and d=Me. (2.2)

To achieve this objective, two keys need to be addressed. First, the inverse of the diagonal matrix must be defined which means that dᵢ≠0 ∀ i. Since dᵢ represents a row sum, this constraint means that each patent must have at least one backward citation. If this constraint is satisfied, by performing the row-normalization technique described as D, a row-stochastic matrix P can be constructed. If this constraint is not satisfied (e.g., a patent is a dangling node), the row sum is 0 (division cannot occur), and the diagonal matrix D=diag(d) is not invertible, so P cannot be constructed.

Second, matrix P must be irreducible. An irreducible graph has a closed form which implies it is strongly connected—from any node in the graph every other node can be reached by following directed links in the graph.

In order to address the problem of dangling nodes and irreducibility, the techniques described herein include augmenting the matrix. In one example, a super node (P₀) is introduced into the network, which may be conceptually viewed as an organization such as the U.S. Patent and Trademark Office. In some aspects of this disclosure, the introduction of a super node creates a bi-directional association between the super node and each patent within the network. The first association, P₀ is cited by all patents, addresses the problem of dangling nodes by providing a backward citation. Meanwhile, the second association, Pₒ cites all patents, in conjunction with the first association, addresses the problem of irreducibility. In other words, the super-node serves as a bridge between any pair of nodes in the network. FIG. 4 illustrates an updated version of the example shown in FIG. 2 to illustrate the inclusion of a super-node (e.g., the Patent Office).

In many aspects of this disclosure, patent scores represent an eigenvector centrality measure from network theory. Such scores simultaneously consider each citation in the valuation of any specific patent in the network. As previously described, the algorithm discussed above addresses the mathematical constraints imposed by the Perron-Frobenius Theorem by including a super node.

In addition, aspects of this disclosure relate to computing the Perron vector using a very efficient technique. Although there are many methods that can be used to compute the dominant eigenvector of a matrix, the most commonly used is the power method. Computationally, this method is a simple iterative procedure. This computation is mathematically equivalent to repeatedly multiplying the matrix P by itself, and identifying any row as the centrality eigenvector.

In a preferred aspect of this disclosure, a super node is included and applied to the network. In doing so, the matrix is reorganized to simplify the linear system through a partitioning schema, grouping patents based on link structure: core patents (patents having both forward and backward citations), dangling nodes (patents having forward citations but not having any backward citations), and dud patents (patents having no forward citations). Here, this partitioned linear system may be solved in a more efficient manner to produce patent scores it that are mathematically equivalent to the power method.

Furthermore, aspects of this disclosure include normalizing the results, so that the minimum score assigned to a patent in the network is one. This aligns directly with traditional count measures and may be a basis for defining equilibrium. A simple patent count gives each patent a score of one, and forward-citation counts (generally referred to as weighted patent counts) gives each patent a minimum score of one if no forward citations exist: WPCₜ=1+Fₜ, that is, at any time t, the forward citations F can be counted which defines the weighted patent count.

### ILLUSTRATIVE EXAMPLE

### Utilizing Calculated Patent Scores

As previously discussed, aspects of this disclosure are directed to utilizing calculated values for a patent to identify a Schumpeterian innovation and corresponding Schumpeterian shock. A Schumpeterian shock is defined herein as a disruption from market equilibrium that can be observed and measured. Identifying such a shock can be useful in evaluating a patent innovation, and in particular, the patent's innovation radicalness. For example, a patent being identified as having a shock may indicate that the patent has value above the market equilibrium. In a dynamic market process every Schumpeterian shock will be unique in context of the current market conditions, such as industry, competition, consumer adoption, and societal benefit.

Alternatively, calculated values for a patent may be utilized to identify a Kirznerian innovation. A Kiznerian innovation is defined herein as an entrepreneurial innovation that has a competitive focus. Generally, a Kirznerian innovation represents an incremental innovation and occurs more frequently than a Schumperian innovation. Meanwhile, a Schumperian innovation generally represents radical innovation.

In the paragraphs that follow, example techniques are discussed with reference to Schumpeterian innovation and Schupeterian shocks, although these techniques may be equally applied to Kirznerian innovations or other classifications of innovations.

In one example, a Schumpeterian shock is identified utilizing cumulative patent scores, calculated as described herein. This technique utilizes patent scores up to the time of the calculation. Alternatively, a Schumpeterian shock may be identified by utilizing a marginal form of these patent scores. This technique identifies the Schumpeterian shock based on the amount of influence a patent innovation has had on the market process recently. To define this amount of influence (e.g., a patent's marginal value) a time frame may be utilized, such as a period of years, months, or days. Accordingly, in one example, a Schumpeterian shock is identified by calculating the patent values for a specified time frame (e.g., a period of five years). These scores may represent deviations from the cyclical flow of business.

Returning to the example shown in FIG. 2, the following includes a description of further techniques for to calculating a patent score or value. Here, the associations of the network can be defined using matrix notation, and using principles of eigenvector centrality, patent scores (eigenvector it) can be computed by equation (3.1) shown below.

π=P^{T}π where P=diag(d)⁻¹M and d=Me (3.1)

By sorting the matrix based on common patent structures, a system of equations can be solved by using linear algebra to efficiently define patent scores. In one example, the adjacency matrix is partitioned into types, augmented to include a super node, such as the U.S. Patent and Trademark Office, row-normalized, and then defined and solved as a partitioned linear system of equations.

In this example, the table of the graph of FIG. 2 is converted to matrix form to define the adjacency matrix M shown below in Equation (3.2).

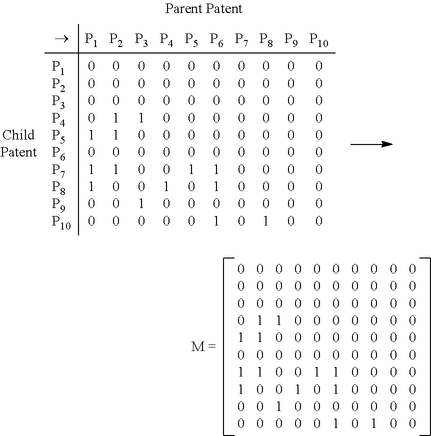

The patents can then be classified as follows:
[Type C₁] Patents with forward citations but without backward citations (dangling nodes), let c₁=size(C₁).
[Type C₂] Patents with both forward and backward citations (core patents), let c₂=size(C₂).
[Type C₃] Everything else (dud patents with no forward citations), let c₃=size(C₃).

In the example of FIG. 2, this classification of patents produces these sets C₁={P₁, P₂, P₃, P₆}, C₂={P₄, P₅, P₈}, and C₃={P₇, P₉, P₁₀). Without loss of generality, the elements of the network can be reorganized by type. Specifically, the elements can be ordered by time and type (σₜᵢₘₑ, σ_{type}),

{P₁, P₂, P₃, P₆, P₄, P₅, P₈, P₇, P₉, P₁₀}=sort(C₁) ∪ sort(C₂) ∪ sort(C₃) (3.3)

and the adjacency matrix can be updated to reflect this reordering,

$$M = [ \begin{matrix}0 & 1 & 1 & 1 & 1 & 1 & 1 & 1 & 1 & 1 & 1 \\ 1 & 0 & 0 & 0 & 0 & 0 & 0 & 0 & 0 & 0 & 0 \\ 1 & 0 & 0 & 0 & 0 & 0 & 0 & 0 & 0 & 0 & 0 \\ 1 & 0 & 0 & 0 & 0 & 0 & 0 & 0 & 0 & 0 & 0 \\ 1 & 0 & 0 & 0 & 0 & 0 & 0 & 0 & 0 & 0 & 0 \\ 1 & 0 & 1 & 1 & 0 & 0 & 0 & 0 & 0 & 0 & 0 \\ 1 & 1 & 1 & 0 & 0 & 0 & 0 & 0 & 0 & 0 & 0 \\ 1 & 1 & 0 & 0 & 1 & 1 & 0 & 0 & 0 & 0 & 0 \\ 1 & 1 & 1 & 0 & 0 & 1 & 1 & 0 & 0 & 0 & 0 \\ 1 & 0 & 0 & 1 & 0 & 0 & 0 & 0 & 0 & 0 & 0 \\ 1 & 0 & 0 & 0 & 0 & 0 & 1 & 0 & 1 & 0 & 0\end{matrix} ] , \\ P = {diag ( d )}^{- 1} M = [ \begin{matrix}0 & \frac{1}{10} & \frac{1}{10} & \frac{1}{10} & \frac{1}{10} & \frac{1}{10} & \frac{1}{10} & \frac{1}{10} & \frac{1}{10} & \frac{1}{10} & \frac{1}{10} \\ 1 & 0 & 0 & 0 & 0 & 0 & 0 & 0 & 0 & 0 & 0 \\ 1 & 0 & 0 & 0 & 0 & 0 & 0 & 0 & 0 & 0 & 0 \\ 1 & 0 & 0 & 0 & 0 & 0 & 0 & 0 & 0 & 0 & 0 \\ 1 & 0 & 0 & 0 & 0 & 0 & 0 & 0 & 0 & 0 & 0 \\ \frac{1}{3} & 0 & \frac{1}{3} & \frac{1}{3} & 0 & 0 & 0 & 0 & 0 & 0 & 0 \\ \frac{1}{3} & \frac{1}{3} & \frac{1}{3} & 0 & 0 & 0 & 0 & 0 & 0 & 0 & 0 \\ \frac{1}{4} & \frac{1}{4} & 0 & 0 & \frac{1}{4} & \frac{1}{4} & 0 & 0 & 0 & 0 & 0 \\ \frac{1}{5} & \frac{1}{5} & \frac{1}{5} & 0 & 0 & \frac{1}{5} & \frac{1}{5} & 0 & 0 & 0 & 0 \\ \frac{1}{2} & 0 & 0 & \frac{1}{2} & 0 & 0 & 0 & 0 & 0 & 0 & 0 \\ \frac{1}{3} & 0 & 0 & 0 & \frac{1}{3} & 0 & 0 & \frac{1}{3} & 0 & 0 & 0\end{matrix} ] . \qquad ( 3.5 )$$

From Equation (3.2), a super node is introduced (P₀), such as the Patent Office, by augmenting this partitioned adjacency matrix. The first row and column are both augmented with binary values to indicate a link to and from the super node. Referring to Equation (3.5), the first association to P₀ (e.g., the Patent Office is cited by each patent) represents the first column of matrix M and the second association to P₀ (e.g., the Patent Office cites all patents) represents the first row of matrix M.

Row-normalization is then performed to define matrix P: (1) the sum of each row is calculated (dᵢ), and (2) the value of each element in the row is divided by its scaling factor dᵢ, which now is such that dᵢ>1. Consider patent P₇ in the example which is highlighted in Equation (3.5). The row P₇ has four backward citations plus the P₀ backward citation, so its scaling factor is now d₇=5. The corresponding row for matrix P is updated by dividing the row in matrix M by the scaling factor d₇:

$$\hat{M} = M ( {σ}_{time} , {σ}_{type} ) = [ \begin{matrix}0 & 0 & 0 & 0 & 0 & 0 & 0 & 0 & 0 & 0 \\ 0 & 0 & 0 & 0 & 0 & 0 & 0 & 0 & 0 & 0 \\ 0 & 0 & 0 & 0 & 0 & 0 & 0 & 0 & 0 & 0 \\ 0 & 0 & 0 & 0 & 0 & 0 & 0 & 0 & 0 & 0 \\ 0 & 1 & 1 & 0 & 0 & 0 & 0 & 0 & 0 & 0 \\ 1 & 1 & 0 & 0 & 0 & 0 & 0 & 0 & 0 & 0 \\ 1 & 0 & 0 & 1 & 1 & 0 & 0 & 0 & 0 & 0 \\ 1 & 1 & 0 & 1 & 0 & 1 & 0 & 0 & 0 & 0 \\ 0 & 0 & 1 & 0 & 0 & 0 & 0 & 0 & 0 & 0 \\ 0 & 0 & 0 & 1 & 0 & 0 & 1 & 0 & 0 & 0\end{matrix} ] . \qquad ( 3.4 )$$

where d=(10, 1, 1, 1, 1, 3, 3, 4, 5, 2, 3) represents each row sum of the augmented matrix M. This specific normalization of one row is addressed within the entire matrix, as defined by Equation (3.1).

Although Equation (3.5) may be solved by a traditional power method and a most efficient linear-algebra method, in the below example, a generalized form of the linear solution is presented, beginning with matrices M and P in partitioned form:

$$M = ( \begin{matrix}0 & {e}_{1}^{T} & {e}_{2}^{T} & {e}_{3}^{T} \\ {e}_{1} & 0 & 0 & 0 \\ {e}_{2} & {Q}^{T} & {R}^{T} & 0 \\ {e}_{3} & {S}^{T} & {T}^{T} & 0\end{matrix} ) , \\ P = ( \begin{matrix}0 & {}_{}^{\frac{1}{n}}{e}{}_{1}^{T} & {}_{}^{\frac{1}{n}}{e}{}_{2}^{T} & {}_{}^{\frac{1}{n}}{e}{}_{3}^{T} \\ {v}_{1} & 0 & 0 & 0 \\ {v}_{2} & {\overline{Q}}^{T} & {\overline{R}}^{T} & 0 \\ {v}_{3} & {\overline{S}}^{T} & {\overline{T}}^{T} & 0\end{matrix} ) \qquad ( 3.6 )$$

where e₁, e₂, e₃ are unitary vectors of size c₁, c₂, c₃, respectively, O is an appropriately dimensioned null matrix, Q_{c1×c2}, R_{c2×c2}, S_{c1×c3}, T_{c2×c3} are submatrices, vᵢ is a normalization of eᵢ, and Q̅, R̅, S̅ and T̅ represent the normalization of each respective submatrix (Q, R, S and T), therefore, P is row-stochastic.

Next, the following is solved for π

P^{T}π=π, (3.7)

which, in partitioned form, is equivalent to

$$( \begin{matrix}0 & {v}_{1}^{T} & {v}_{2}^{T} & {v}_{3}^{T} \\ {}_{}^{\frac{1}{n}}{e}{}_{1}^{} & 0 & \overline{Q} & \overline{S} \\ {}_{}^{\frac{1}{n}}{e}{}_{2}^{} & 0 & \overline{R} & \overline{T} \\ {}_{}^{\frac{1}{n}}{e}{}_{3}^{} & 0 & 0 & 0\end{matrix} ) ( \begin{matrix}{π}_{0} \\ {π}_{1} \\ {π}_{2} \\ {π}_{3}\end{matrix} ) = ( \begin{matrix}{π}_{0} \\ {π}_{1} \\ {π}_{2} \\ {π}_{3}\end{matrix} ) . \qquad ( 3.8 )$$

Writing the eigenvalue relation as a linear system is

$$\{ \begin{matrix}{v}_{1}^{T} {π}_{1} + {v}_{2}^{T} {π}_{2} + {v}_{3}^{T} {π}_{3} = {π}_{0} \\ \frac{{π}_{0}}{n} {e}_{1} + \overline{Q} {π}_{2} + \overline{S} {π}_{3} = {π}_{1} \\ \frac{{π}_{0}}{n} {e}_{2} + \overline{R} {π}_{2} + \overline{T} {π}_{3} = {π}_{2} \\ \frac{{π}_{0}}{n} {e}_{3} = {π}_{3}\end{matrix} \qquad ( 3.9 )$$

Among the infinite vectors, which are solutions to the linear system in Equation (3.9), the vector which assigns a score equal to n to the super node P₀ (e.g., the Patent Office) is chosen, that is, π₀=n. Then is obtained by substitution

$$\{ \begin{matrix}{π}_{3} = {e}_{3} \\ {π}_{2} = {( I - \overline{R} )}^{- 1} ( {e}_{2} + \overline{T} {e}_{3} ) \\ {π}_{1} = {e}_{1} + \overline{Q} {π}_{2} + \overline{S} {e}_{3}\end{matrix} \qquad ( 3.10 )$$

where the subscript defines the patent scores for the specific type of patents. For example, π₃=e₃ represent the patent scores for dud patents (of Type C₃), they are assigned trivial scores of “1”s. From the system of solutions identified in Equation (3.10), it is noted that π₁ can be solved via substitution once n₂ is calculated. In essence, the partitioning technique has reduced the (n+1)×(n+1) problem to a c₂×c₂ system. Thus, the following simply needs to be solved

(I− R̅)π₂=(e₂+ T̅e₃). (3.11)

This technique normalizes the vector of patent scores π such that the minimum score a patent receives is one (π₃=e₃). This conveniently anchors the patenting scoring method to traditional patent-valuation measures: simple patent count and weighted patent count. By definition, a simple patent count assigns each patent a score of one, a weighted patent count assigns each patent a score of 1+F where F is the number of forward citations (minimum score is also one). This minimal value means the patent exists in the network, yet has no intrinsic value at the observed point in time.

From construction of the techniques discussed above, including construction of a model, there are four key attributes to define and compute patent scores at a particular point in time t. The first, f as the formation of the network, describes how the network is defined. In one example, a cumulative model, or total-effects model, indicates that the network is defined to include each and every patent and association (f=c). Alternatively, a marginal model, or local-effects model, may be defined of patents and associations in a moving window (f=m), such as a 5-year window (f=m=5 years). However, other models could be specified to determine which patents to include in the network analysis. In one example, in the generalized model, the theoretical assumptions regarding the formation of the network f will influence the results of the network analysis.

The remaining three generalizable attributes are related to definition of the adjacency matrix and its augmentation. The definition of association of matrix M can also be generalized (m). Recall that the, adjacency matrix M presented above contains binary data (”1”s and “0”s) to indicate the presence or absence of a link between two nodes. This dichotomous schema is defined as a Structure or Structure-Only model, and is one of many schemas that could be defined. For example, the defined schema could include additional information about the value of each association. That is, a metric could be used to describe the strength of association, not merely its presence. In addition, a measure of similarity could be included to these patent associations that was determined by a patent owner. For example, technology classifications, field of search, or international classifications could be compared to define a soft-match. This soft-match could be considered in calculating a patent score. Stated mathematically, (mⱼᵢ) would represent an association between patent Pᵢ and patent Pⱼ.

Analogous to this type of match, associations between patents and the super node, such as the Patent Office (P₀), could also be defined. This second generalization updates the augmented adjacency matrix M by replacing this augmented row and column of “1″s with unique values. In one example, the augmented row and column could be replaced with weighted values, such as illustrated in FIG. 7. The binary “1”s are replaced with appropriate relational weighting factors. Most generally, the first column can be represented as a vector a where each patent Pᵢ could be uniquely weighted by a factor a, to represent its first association with the Patent Office. Similarly, the first row can be represented as a vector β where each patent Pᵢ could be uniquely weighted by a factor βᵢ to represent its second association with the super node.

In generalized form, this technique allows for asymmetric associations with the super node P₀. Here, the matrix may be weighted based on the association with the super node. Such weighting may include: (1) weighting each patent's association based on the time it took the patent to grant, (2) weighting each patent's association based on industry controls (e.g., pharmaceutical patents are more stringently regulated, so all of these patents could be dampened by some constructed regulation factor), (3) weighting each patent's association based on years remaining (e.g., utility patent protection generally endures for twenty years from the time the application was filed), (4) weighting each patent's association based on some external factor such as the payment of renewal fees or a patent's litigation value, and/or (5) any other factor associated with patents within the subject patent network.

Utilizing this generalized model specification, the base model from Equation (3.6) can be updated in a general form π(t)_{fabm}:

$$π = {P}^{T} π \\ where \\ M = ( \begin{matrix}0 & {β}_{1}^{T} & {β}_{2}^{T} & {β}_{3}^{T} \\ {α}_{1} & 0 & 0 & 0 \\ {α}_{2} & {Q}^{T} & {R}^{T} & 0 \\ {α}_{3} & {S}^{T} & {T}^{T} & 0\end{matrix} ) \\ and \\ P = ( \begin{matrix}0 & {u}_{1}^{T} & {u}_{2}^{T} & {u}_{3}^{T} \\ {v}_{1} & 0 & 0 & 0 \\ {v}_{2} & {\overline{Q}}^{T} & {\overline{R}}^{T} & 0 \\ {v}_{3} & {\overline{S}}^{T} & {\overline{T}}^{T} & 0\end{matrix} ) . \qquad ( 3.12 )$$

where t represents when the network was formed, f represents how the network is formed (e.g., cumulative as π(7609)_{c} or marginal as π(8690)ₘ), a represents the prior associations with P₀ (e.g., structural as a=1 or other as a=α(renewal fees)), b represents the posterior associations with P₀ (e.g., structural as b=1 or other as b=β(litigation)), and m represents the associations among nodes (e.g., structural as s, ClassMatch as c). The partitioning of the matrices is based on the classification of patents.

The only constraint on these associations, is that every element defined is strictly positive (αᵢ>0 and βᵢ>0 and (mᵢⱼ)>0). This ensures that the patent scores π can be computed.

In this example, introducing such additional weighting factors changes the nature of the network, and therefore, changes the final patent scores. Mathematically, the first column of the adjacency matrix M, partitioned accordingly with the three blocks, becomes α=(α₁, α₂, α₃)^{T}, while the first row is β=(β₁, β₂, β₃)^{T}. Without loss of generality, the linear system can be solved to identify patent scores, Equation (3.6) is updated as follows:

$$M = ( \begin{matrix}0 & {β}_{1}^{T} & {β}_{2}^{T} & {β}_{3}^{T} \\ {α}_{1} & 0 & 0 & 0 \\ {α}_{2} & {Q}^{T} & {R}^{T} & 0 \\ {α}_{3} & {S}^{T} & {T}^{T} & 0\end{matrix} ) , \\ P = ( \begin{matrix}0 & {u}_{1}^{T} & {u}_{2}^{T} & {u}_{3}^{T} \\ {v}_{1} & 0 & 0 & 0 \\ {v}_{2} & {\overline{Q}}^{T} & {\overline{R}}^{T} & 0 \\ {v}_{3} & {\overline{S}}^{T} & {\overline{T}}^{T} & 0\end{matrix} ) \qquad ( 3.13 )$$

where the row-normalization of vᵢ and uᵢ and the partitioned matrices (e.g., Q) are altered to account for these new asymmetric values of aᵢ and A. Note that if all the βᵢ's are the same, the normalization of the first row, will produce vectors uᵢ=1/n eᵢ equivalent to the case where all the βᵢ's are equal to one. Repeating the same calculation performed in Equations from (3.8) to (3.10), and setting π₀=n, the following system results, which replaces the system defined in Equation (3.10).

$$\{ \begin{matrix}{π}_{3} = n {u}_{3} \\ {π}_{2} = {( I - \overline{R} )}^{- 1} ( n {u}_{2} + \overline{T} {π}_{3} ) \\ {π}_{1} = n {u}_{1} + \overline{Q} {π}_{2} + \overline{S} {π}_{3}\end{matrix} \qquad ( 3.14 )$$

which still requires only the solution of a c₂×c₂ linear system. Note now that, since in general u₃≠1/n e₃, the minimum patent score can be less than 1, yet still positive.

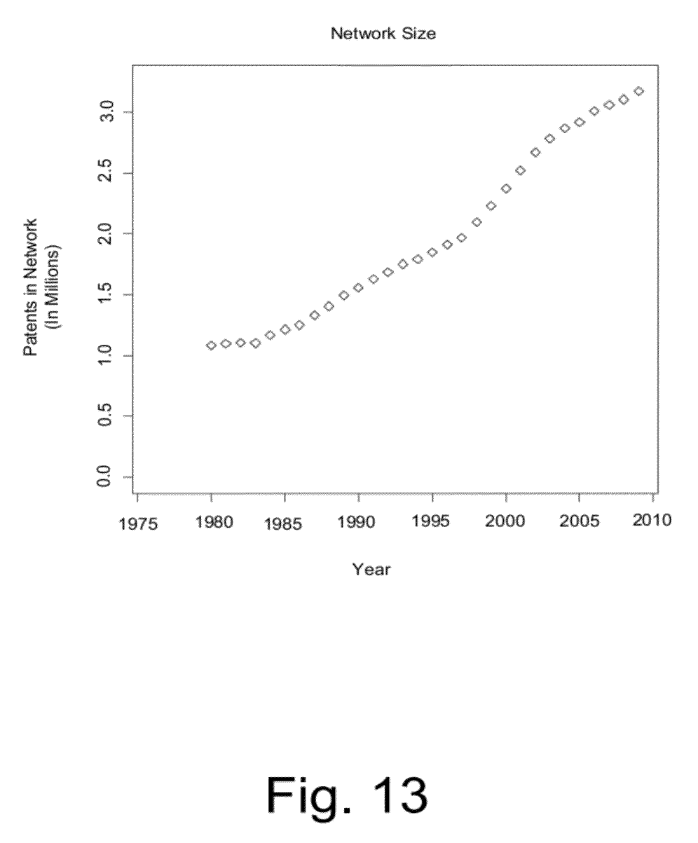

In one example, the above techniques are utilized with an example data set to calculate a patent value utilizing the marginal model. In this example, a patent network of the data set is temporarily constrained based on the year the patent was granted. FIG. 13 summarizes some general trends regarding the size of the network formation at a specific marginal time with this data set. Here, if a patent was granted in the particular marginal window (e.g., 1976-1980), it will be included in the analysis. For example, a patent granted in 1980 will appear in a patent network for 1976-1980, 1977-1981, 1978-1982, 1979-1983, 1980-1984 because it granted in 1980. If the patent has no influence on the patent network based on this marginal formation, during this mandatory inclusion period, this patent would receive the minimal, trivial score of “1”. If, however, the patent appears in the network formation after the moving window has left 1980, it is because the patent has some measurable deviation from equilibrium.

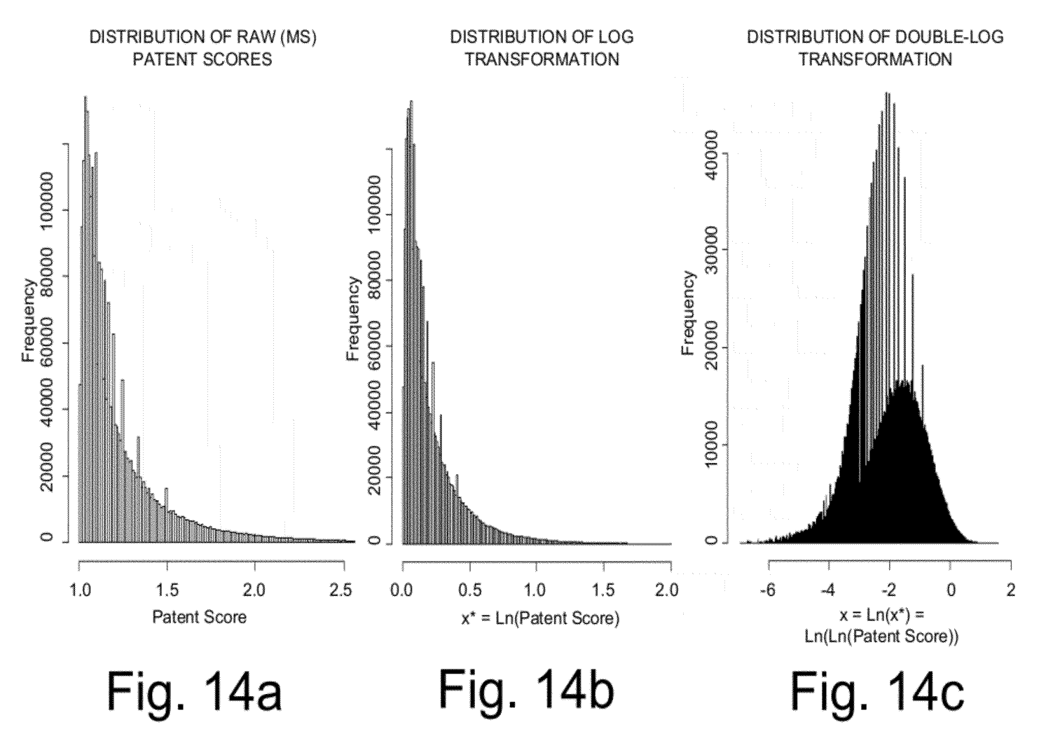

FIGS. 14a-c illustrate example distributions for an example data set using one model specification from a generalized form of the techniques described herein. Details of these figures are further described below.

As discussed above, Schumpeterian shocks may exist among Austrian-based, marginal (ms) patent scores. In many instances, the distributions (intensity, volume) derived from the (ms) patent scores may be skewed and appear to follow a power-law distribution. Such distributional results are common in the study of extremely rare events and natural phenomenon. To further explore this phenomenon, one example considers a set (2005-2009 as t=0509) of (ms) patent scores. Here, FIG. 14a illustrates the distribution of all nontrivial scores—scores that are not assigned the minimum score of “1” (dud patents are excluded as they have no shock value). Further, even a natural logarithmic transformation, as shown in FIG. 14b, does not improve the skewness. However, as illustrated in FIG. 14c, a double logarithmic transformation normalizes the data into what appears to be a Gaussian mixture. This result is uncommon for power-law distributions, but may be identified as the first citation network that has such beneficial distributional properties. The monotonic transformation is mathematically defined as:

x=ln(ln(π)) for all elements where πᵢ>1, (3.15)

which implies π=ee^{e}^{^{x}}. Here, this may suggest that there is a mixture of two types of structures in the patent market process. The right-most normal curve is smaller, and has the highest overall double-log transformed (ms) patent scores (e.g., radical). Meanwhile, the left-most normal curve appears disjoint and truncated, but is larger, and has the lowest overall double-log transformed (ms) patent scores (e.g., incremental). In one example, more patents will have the exact same score if they imitate a common patent-citation structure.

As discussed below, aspects of this disclosure also relate to improving normality of the disjoint double-log-normal distribution seen in FIG. 14c by determining how to define the adjacency matrix M (based on network information), so that the model produces results with beneficial distributional properties. In other words, one example includes updating the adjacency matrix M to include additional information about the strength of any link between two patents. Recall that the adjacency matrix M discussed above contains binary data (“1”s and “0”s) to indicate the presence or absence of a link between two nodes. This dichotomous schema is defined as a Structure or Structure-Only model. However, in one example, a different schema can be used, which includes additional information about the value of each association. Here, two patents are compared in terms of similarity based on their shared technology classifications and is defined as:

ClassMatch (X, Y)=ΣProb(C_{X}_{ᵢ})∩Prob(C_{Y}_{ⱼ}) (3.16)

which is essentially a soft-match or overlap of intersecting technologies which demonstrates patent relatedness. This schema can be combined with the Structure matrix or used independently. In one example, a combined approach provides very similar scores to the Structure and “ClassMatch” models with improvement in the double-log-normal distribution. Updating the cumulative π(t)_{cs} and marginal π(t)ₘₛ structural models, combined models π(t)_{cc} and π(t)_{mc} are respectively specified. Based on structural and temporal considerations, the four basic patent models are summarized below.

Here, these four models assume α and β are both “1,” equally weighted, symmetric associations with the super node.

Formation

| | | Structure-Only | Combined |
|---|---|---|---|
| Temporal | Cumulative | (cs) | (cc) |
| | Marginal | (ms) | (mc) |

### ILLUSTRATIVE EXAMPLE

### Predicting Patent Value

This section provides various techniques to assess patent innovation and predict patent value (e.g., an expected life time value of a patent). Such assessments and predictions can be used for a wide array of purposes, such as internal venturing (i.e., within a company), external venturing, and generally managing innovation.

Although the techniques below are discussed in the context of calculating the patent scores using weighted forward and backward citations, these techniques may also be applied using patent values calculated through other means. For example, a patent value calculated based on only equally weighted forward citations may be utilized.

In assessing the value of a patent, many of the techniques discussed above may be utilized as an indicator of a Schumpeterian shock. In one example, the annual scores of the (mc) model are utilized to indicate a Schumpeterian shock. Here, the (mc) model is marginal and combined. Marginal means it considers the patent's intrinsic value in a temporally-constrained network. For example, to compute the patent's intrinsic value in 2005, the network may be formed to include recent patent associations, such as associations from 2001 to 2005. To compute the patent's intrinsic value in 2006, meanwhile, the network may be formed to include patent associations from 2002 to 2006, and so on. Combined means the associations are defined within the network as “present and being this strong” based on the technology overlap of a patent and its citation.

In one example, to assess just one patent, the entire network is formed, scores are computed for every patent in the network based on the model specifications, and then the single patent's score is reported. These scores can be computed longitudinally to ascertain the changes in a patent's intrinsic value over time. These longitudinal computations of patent scores for a single patent uniquely define a Schumpeterian shock (see FIG. 9) based on intensity, duration, and total volume (shaded region). This shock pattern represents how the given patent influences the patent network and ultimately the market place.

As illustrated in FIG. 10, the data representing the Schumperterian shock can be used to predict an expected lifetime value of a patent. In one implementation, a Schumpeterian shock is converted to a trajectory model using the generalized logistic function, commonly referred to as the Richards' curve:

$${Y}_{it} = f ( {X}_{it} ; {{Θ}_{\sim}}_{it} ) = f ( {X}_{it} ; {β}_{it} , {δ}_{it} , {τ}_{it} ) = \frac{{β}_{it}}{( 1 + {e}^{- {δ}_{it} ( {X}_{it} - {τ}_{it} )} )} \qquad ( 4.1 )$$

where Yᵢₜ represents the total volume of the Schumpeterian shock for patent i measured in year Xᵢₜ utilizing information up-to, and including time t.

Although more parameters could be used in the generalized logistic function, a three-parameter model is used here which captures the maximum growth rate δ (growth), the time of maximum growth τ (velocity), and the ceiling value β (volume) which represents the expected total volume of the Schumpeterian shock. In this example, the patent scores are computed annually, and the shock pattern and resulting modeled trajectory are updated every year. FIGS. 11a-d and 12a-d illustrate an example of how this modeling procedure updates over time.

In one aspect of this disclosure, these three parameters facilitate prediction of patents that have high expected values β (volume) and patents that have low expected values. Among the patents that have high expected values are patents with slower and faster growth rates δ (growth). Faster growth rates indicates more potential for overall value, while slower growth rates over a longer time period can still have value. In one example, the patents that have high expected growth rates are defined based on two parameters.

In assessing a patent at a specific time, at least the following options are available: (1) use of the actual value, (2) use of changes in the actual value, (3) use of the expected value β, and (4) use of changes in the expected value. Furthermore, to assess a firm's patent portfolio a sum any of these four options can be used. From this, additional valuation-options can be developed, including: (a) normalizing a firm's portfolio by dividing the total score by the number of patents present in the network, an averaging technique, and (b) creating standardized scores within a firm over time.

In one implementation, decision rules are generated to identify patents that have high expected values and patents that have low expected values among a portfolio of patents. Patents that have high expected values can be further identified as patents with slower growth rate over a longer period of time and patents with faster growth rates. In this implementation, for a given grant period, the most recent modeled values are identified for growth δ, speed τ, and volume β. if a patent's growth δ is slower than half of the sample for the period, the patent can be flagged as potentially being a patent with slower growth rate over a longer time period, it also must demonstrate value (i.e., the patent falls in the upper quartile based on volume β). If both of these conditions are met, the patent can be identified as a patent with high expected values having slower growth rate over a longer period of time. On the other hand, patents with high expected values and faster growth rates can be identified when the patent is faster (δ) than ¾ of the sample and belongs to the top 10% of all patents based on volume β. Finally, regardless of growth, a patent can be identified as a patent which appears to have value if it belongs to the lowest quartile based on volume β.

### ILLUSTRATIVE EXAMPLE

### Assessing Patent Value at a Firm Level

The next section provides an example for applying the techniques discussed above to assess patent value for a firm (e.g., a company, organization, etc.). This application may include analyzing a single patent or a plurality of patents (e.g., a patent portfolio of a firm).

In one example, a single patent's expected lifetime value for a given year is evaluated. Here, the network is first formed using the (mc) model described above, with any deviations above the nontrivial score of “1” defining the patent's Schumpeterian shock. That is, a firm has zero value as radical innovation unless it diffuses within the network. In this example, the (mc) patent score is computed each year for the patent, and the diffusion pattern of the patent's unique Schumpeterian shock is longitudinally observed. When enough data is available, the total volume of the Schumpeterian shock is modeled using the generalized logistic function (e.g., a nonlinear S-curve).

As discussed above, a three-parameter form of the Richards' curve may be utilized to model a patent's expected lifetime value:

$${Y}_{it} = f ( {X}_{it} ; {{Θ}_{\sim}}_{it} ) = f ( {X}_{it} ; {β}_{it} , {δ}_{it} , {τ}_{it} ) = \frac{{β}_{it}}{( 1 + {e}^{- {δ}_{it} ( {X}_{it} - {τ}_{it} )} )}$$

where Yᵢₜ represents the total volume of the Schumpeterian shock for patent i measured in year Xᵢₜ utilizing information up-to, and including time t. The selected three-parameter model helps identify key aspects of the growth of a patent innovation: the maximum growth rate δ, the time of maximum growth τ, and the ceiling value β which represents the expected total volume of the Schumpeterian shock.

In one example, parameter estimates provide information about the growth rate δₜ, the time of maximum growth τₜ, and the expected ceiling βₜ. Here, βₜ is defined to represent the expected lifetime value for a patent at time t. Meanwhile, another year passes and similar calculations are performed (t+1). Here, Δβₜ₊₁ is defined to be the difference between βᵢ₊₁ and βₜ. Since each patent innovation is atomic, discrete, and unique, the expected patent lifetime values βₜ and changes Δβᵢ₊₁ is summed to similarly define a firm's patent stock and changes in patent stock.

As discussed above, at least four different models may be utilized to determine a patent's value. In one example, the quality of any patent over time may be determined based on these models. Here, patent scores may be annually calculated for the four different models:
(cs) This is the most basic model, a cumulative-structure model, and is useful in identifying the originating innovation.
(cc) This model, cumulative-combined, is also useful in identifying the originating innovation while accounting for the technological overlap of a patent and its citation.
(ms) This model, marginal-structure, is useful in identifying a patent's marginal utility, a fundamental principle of Austrian economics.
(mc) This model, marginal-combined, is also useful in identifying a patent's marginal utility while accounting for the technological overlap of a patent and its citation.

In addition, further techniques and models may be utilized in assessing changes in a firm's patent portfolio. Here, these changes may indicate a firm's market returns.

As discussed above, to assess a patent at a specific time, several options are available: (1) using the actual value, (2) using changes in the actual value, (3) using the expected value β, or (4) using changes in the expected value. Further, to build a patent portfolio any of the four options above can be summed. From this, additional valuation-options can be developed: (a) a firm's portfolio can be normalized by dividing the total score by the number of patents present in the network, an averaging technique, or (b) standardized scores within a firm over time can be created.

In one implementation, a Fama-French/Carhart four-factor model may be utilized to compute portfolio returns of a firm. This model is defined as:

Rⱼₜ−R_{ft}=αⱼ+βⱼ(Rₘₗ−R_{ft})+sⱼ(SMBₜ)+hⱼ(HMLₜ)+hⱼ(UMDₜ)+εⱼₜ

where j represents a portfolio, t is a month, Rⱼₜ is the median return for portfolio j at time t, R_{ft} is the risk-free rate for time t, Rₘₜ is the market return for t, βⱼ is the classical CAPM β for portfolio j, sⱼ is the coefficient associated with size of market capitalization (SMB as small minus big) for portfolio j, sⱼ is the coefficient associated with value/growth (HML as high minus low book-to-market ratio) for portfolio j, uⱼ is the coefficient associated with momentum (UMD as up minus down) for portfolio j, εⱼₜ is the disturbance (residuals from unobservables) forportfolio j at time t, and αⱼ+εⱼₜ is defined as the abnormal return for portfolio j. Abnormal returns represent excess returns, that is, returns above and beyond the market's risk-free rate.

This model controls for risk where risk is decomposed into the four factors: market risk, firm-size risk, value/growth risk, and momentum risk. Industry is another control that may be considered.

Meanwhile, changes in patent stock for a firm for a specified period of time, such as for the year 1995, may be computed.. This change includes information about the total patent stock at the end of the period of time, the year 1995. In an efficient market, this information should diffuse throughout the year, so the change is linked to monthly returns during the year 1995.

Here, a patent portfolio may be created based on some decision criteria (e.g., a firm has patents or doesn't) and all month-firm observations that fit the criteria are thrown into a portfolio. For a given month, the median return from the portfolio in the Fama-French/Carhart model may be utilized.

### Conclusion

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method of predicting a potential value of a patent, comprising:
calculating a plurality of patent values for a patent, each of the plurality of patent values comprising the patent value of the patent at a respective point in time; and
generating a predicted potential value of the patent based at least in part on the plurality of patent values, the predicted potential value of the patent at least partly representing a future value of the patent.

2. The method of claim 1, wherein the calculating includes calculating the plurality of patent values based at least in part on a predetermined window of time that is determined with reference to a time associated with the patent.

3. The method of claim 2, wherein the time associated with the patent comprises a filing date of the patent, an issue date of the patent, or a publication date of the patent.

4. The method of claim 1, further comprising:
utilizing a double logarithmic transformation to normalize the plurality of patent values.

5. The method of claim 1, wherein the predicted potential value includes or is based at least in part on a velocity parameter indicating a velocity at which the patent value of the patent is predicted to change with time, a growth parameter indicating how the patent value of the patent is predicted to grow with time, and an expected-patent-lifetime-value parameter indicating a predicted total patent value of the patent over a lifetime of the patent.

6. The method of claim 1, further comprising:
modeling a trajectory of the predicted potential value patent by utilizing a generalized logistic function defined by:
$${Y}_{it} = \frac{{β}_{it}}{( 1 + {e}^{- {δ}_{it} ( {X}_{it} - {τ}_{it} )} )}$$
where δ represents a maximum growth rate, r represents a time of maximum growth, β represents an expected total volume of a shock, and Yᵢₜ represents a total volume of the shock for patent i measured in year Xᵢₜ utilizing information up-to and including time t.

7. The method of claim 1, wherein:
the plurality of patent values include a first patent value and a second patent value; and
the calculating includes:
calculating the first patent value based at least in part on values of other patents that were filed or issued during a predetermined period;
updating the predetermined period to begin at a different time; and
calculating the second patent value based at least in part on values of other patent that were filed or issued during the updated predetermined period.

8. The method of claim 1, wherein:
the plurality of patent values include a first patent value corresponding to a first time and a second patent value corresponding to a second time; and
the calculating includes:
calculating the first patent value based at least in part on values of other patents filed or issued on or before the first time, and
calculating the second patent value based at least in part on values of other patents filed or issued on or before the second time.

9. The method of claim 1, further comprising:
modeling a trajectory of the patent based at least in part on the predicted potential value of the patent; and
displaying the modeled trajectory using an S-curve.

10. The method claim 9, wherein:
the plurality of patent values include a first patent value and a second patent value; and
the displaying includes:
displaying the S-curve having a shape based on the first patent value;
expanding or contracting the shape of the S-curve based on the second patent value; and
displaying the expanded or contracted S-curve.

11. The method of claim 9, wherein the displaying includes animating the S-curve based at least in part on the plurality of patent values.

12. A system, comprising:
one or more processors; and
memory, communicatively coupled to the one or more processors, storing a prediction module configured to:
calculate a plurality of patent values for a patent, each of the plurality of patent values comprises the patent value of the patent at a respective point in time; and
generate prediction data based at least in part on the plurality of patent values, the prediction data indicating a predicted potential of the patent.

13. The system of claim 12, wherein the predicted data includes or is generated based at least in part on a velocity parameter indicating a velocity at which the patent value of the patent is predicted to change with time, a growth parameter indicating how the patent value of the patent is predicted to grow with time, and an expected-patent-lifetime-value parameter indicating a predicted total patent value of the patent over a lifetime of the patent.

14. The system of claim 12, wherein the prediction module is further configured to model a trajectory of the patent by utilizing a generalized logistic function defined by:
$${Y}_{it} = \frac{{β}_{it}}{( 1 + {e}^{- {δ}_{it} ( {X}_{it} - {τ}_{it} )} )}$$
where δ represents a maximum growth rate, r represents a time of maximum growth, β represents an expected total volume of a shock, and Yᵢₜ represents a total volume of the shock for patent i measured in year Xᵢₜ utilizing information up-to and including time t.

15. The system of claim 12, wherein:
the plurality of patent values include a first patent value and a second patent value; and
the prediction module is further configured to:
calculate the first patent value based at least in part on values of other patents that were filed or issued during a predetermined period;
update the predetermined period to begin at a different time; and
calculate the second patent value based at least in part on values of other patent that were filed or issued during the updated predetermined period.

16. The system of claim 12, wherein:
the plurality of patent values include a first patent value corresponding to a first time and a second patent value corresponding to a second time; and
the prediction module is further configured to:
calculate the first patent value based at least in part on values of other patents filed or issued on or before the first time, and
calculate the second patent value based at least in part on values of other patents filed or issued on or before the second time.

17. The system of claim 12, wherein the prediction module is further configured to:
model a trajectory of the patent based at least in part on the predicted potential value of the patent; and
display the modeled trajectory using an S-curve.

18. The system of claim 17, wherein:
the plurality of patent values include a first patent value and a second patent value; and
the prediction module is further configured to:
display the S-curve having a shape based on the first patent value;
expand or contracting the shape of the S-curve based on the second patent value; and
display the expanded or contracted S-curve.

19. The system of claim 17, wherein the prediction module is configured to display by animating the S-curve based at least in part on the plurality of patent values.

20. The system of claim 12, wherein the prediction module is configured to calculate the plurality of patent values based at least in part on a forward citation of the patent, the forward citation being a citation in another patent to the patent.

21. One or more computer-readable media storing computer-executable instructions that, when executed by one or more processors, cause the one or more processors to perform acts comprising:
calculating a plurality of patent values for a patent, each of the plurality of patent values comprising the patent value of the patent at a respective point in time; and
generating a predicted potential value of the patent based at least in part on the plurality of patent values, the predicted potential value of the patent at least partly representing a future value of the patent.
